(19) United States
(12) Patent Application Publication
(10) Pub. No.: US 2005/0119077 A1
(43) Pub. Date: Jun. 2, 2005

(54) Assembly and method of assembling a motor vehicle alternator pulley and a motor vehicle alternator comprising one such assembly

(76) Inventors: Guy Faucon, Lyon (FR); Virginie Leroy, Neuilly Plaisance (FR); Karine Stofleth, Maisons Alfort (FR)

Correspondence Address: Longacre & White, 6550 Rock Spring Drive, Suite 240, Bethesda, MD, 20817, US

(21) Appl. No.: 10/506,324

(22) PCT Filed: Mar. 24, 2003
(86) PCT No.: PCT/FR03/00918

(30) Foreign Application Priority Data
Mar. 22, 2002 (FR) 02/03803

(51) Int. Cl. F16H 9/00; F16H 63/00; F16H 55/36

(52) U.S. Cl. 474/70; 474/170; 474/182; 474/903

(57) ABSTRACT

This invention proposes a combination of a drive pulley (30) with the rotor of a rotary electrical machine for a motor vehicle, especially an alternator or alternator-starter, comprising, firstly, a shaft (18) carrying a rotor and a front ball bearing (26), and secondly, a pulley (30) which has a peripheral working zone (92) arranged to cooperate with a drive belt, together with a central hub (93) which has an axial hole (94) for the rotor shaft (18) to pass through it, characterised in that the pulley (30) has a splined internal portion (95) such that it can be force-fitted on a complementary splined external portion of the rotor shaft (18).

### TECHNICAL FIELD OF THE INVENTION

The present invention relates to the combination of a drive pulley with the rotor of a rotary electrical machine for a motor vehicle.

In particular, the invention relates to the fitting of an alternator pulley for a motor vehicle.

The pulley enables the alternator rotor to be driven using a drive belt.

More particularly, the invention relates to an assembly of a motor vehicle alternator pulley that does not have a decoupling device of the “free wheel” type, which would enable the torque to be transmitted in only one direction of rotation.

### STATE OF THE ART

In this field, combinations are known of the type in which the pulley includes a peripheral working zone which is arranged to cooperate with a drive belt, together with a central hub which has an axial hole for passage of the shaft of the rotor through it.

In order to couple the pulley in rotation to the rotor shaft, the central hub of the pulley is mounted freely on the end portion of the shaft, that is to say the latter includes a smooth portion which extends through a complementary portion of the axial hole of the hub of the pulley, and the central hub is clamped or gripped axially between the inner race of a rolling bearing for guiding the rotor shaft in rotation and a fastening nut which is screwed on a threaded portion at the free end of the rotor shaft.

A washer may be interposed axially between the pulley and the nut, and the value of the torque that resists sliding movement of the pulley on the shaft depends on the value of the tightening torque of the nut.

However, the value of this torque is limited by the strength of the materials in compression or in tension, the various components of the assembly, and the surface conditions of those parts of the components which are in contact with each other.

It is indeed found that loosening of the pulley can occur in the case of some applications in which a very high torque has to be transmitted by the pulley-rotor combination, and/or the latter is subjected to exceptional stresses resulting from tension in the drive belt.

Such loosening effects can also occur in the event of the torque to be transmitted varying acyclically as a result of the behaviour of the engine. Pulleys provided with freewheel devices are much more sensitive to these loosening effects, because of their construction which only enables the rotary torque to be transmitted in one direction.

The alternator enables a rotary movement of the inductor rotor, driven by the engine of the vehicle, to be converted into an electric current induced in the windings of the stator. The alternator can also be reversible, and can constitute an electric motor; its stator then works as an inductor and its rotor as an armature, enabling the engine of the vehicle to be driven in rotation via the rotor shaft. This reversible alternator is called an alternator starter, and it converts mechanical energy into electrical energy and vice versa. Thus, an alternator starter is able to start the engine of the motor vehicle, may constitute an auxiliary motor for driving for example an air conditioning compressor, or, again, is able to operate in a motor mode to drive the motor vehicle. In general terms, the stator includes three windings such that the alternator is of the three-phase type. In another version, the alternator is of the six-phase type, and may be wound with conductive bars formed as hairpins. Where the alternator starter is working in the starter mode, that is to say the motor mode, it has to transmit to the engine a very high torque. In this working mode, torque transmission by friction is insufficient, and sliding effects, or even loosening of the pulley, are observed.

The document U.S. Pat. No. 5,418,400 describes an alternator starter in which the pulley is fitted on a knurled shaft. However, the transmission of the torque through a pulley which is assembled by knurling on a shaft which is arranged accordingly makes it necessary to add an additional nut in order to transmit a high torque. In this connection, fastening by knurling alone proves insufficient.

### DISCLOSURE OF THE INVENTION

In order to overcome these disadvantages, the invention proposes the combination of a drive pulley with the rotor of a rotary electrical machine for a motor vehicle, especially an alternator or an alternator starter, comprising, firstly, a shaft carrying a rotor and a front ball bearing, and secondly, a pulley having a peripheral working zone adapted to cooperate with a drive belt, together with a central hub having an axial hole for passage of the shaft of the rotor through it, in which the pulley includes a splined inner portion for its attachment, by force-fitting, on a complementary splined outer portion of the shaft of the rotor.

Thus, the arrangement according to the invention enables the maximum torque that can be transmitted by the pulley-rotor combination to be no longer dependent on the axial gripping of the pulley, that is to say on the tightening torque of the nut in the state of the art. By virtue of the invention it is therefore possible to obtain an alternator starter or an alternator which does not have a nut for securing the pulley.

The invention also proposes a method of assembling the combination described above, in which, starting with a pulley having a transverse front base portion, an axially oriented annular extension portion with a transverse shoulder, and a central front aperture,
a threaded rod is fitted by screw fastening in a threaded hole in the shaft of the rotor;
an axially oriented annular extension portion of the pulley is offered up to a pilot end configuration of the shaft;
the pulley is indexed by placing its splines in facing relationship with the teeth of the shaft;
a spacing piece, having an internal bore and a tubular rear end portion, is mounted within a central front aperture of the pulley, a rear face of the tubular rear end portion of the spacing piece coming into abutment against the transverse front base portion of the pulley, while the threaded rod passes freely into the interior of the bore of the spacing piece;
a nut is screwed on the threaded rod in contact with the front face of the spacing piece, whereby to offer up, and firmly hold, the pulley on the pilot end configuration of the free front end portion of the shaft;
the threaded rod is held against movement;
the nut continues to be screwed up towards the rear along the threaded rod, whereby to fit the pulley over the splined external portion of the shaft, so as to exert a pulling force on the shaft;
the screwing-up operation is stopped when the transverse shoulder on the pulley comes into abutment against the axial front end of the inner ball race (50) of the front ball bearing of the electrical machine; and
the threaded rod, carrying the spacing piece and the nut, is withdrawn.

In this way a method of assembly which is simple, reliable and inexpensive is obtained for the pulley-rotor combination according to the invention.

### BRIEF DESCRIPTION OF THE DRAWINGS

Further features and advantages of the invention will appear on a reading of the following detailed description, for an understanding of which reference will be made to the attached drawings, in which:

FIG. 1 is a view in axial cross section showing part of an alternator in the state of the art,

FIG. 2 is an axial view of an alternator rotor shaft according to the invention,

FIG. 3 is an axial view of an alternator pulley according to the invention,

FIG. 4 is an axial view of an alternator pulley mounted on the rotor shaft according to the invention,

FIGS. 5a, 5b and 5c are views which illustrate the procedure for fitting the pulley on the rotor shaft according to the invention,

FIG. 6 is a modified embodiment of the invention of FIG. 2,

FIG. 7 is a view at right angles to the axis X-X of an alternator rotor shaft according to the invention, and

FIG. 8 is a view at right angles to the axis X-X, showing an alternator pulley according to the invention.

### DETAILED DESCRIPTION OF EMBODIMENTS OF THE INVENTION

In the following description, identical, analogous or similar components will be designated by the same reference signs.

In order to facilitate understanding of the Description and Claims, an orientation from front to rear that goes from right to left will be adopted (though without limitation).

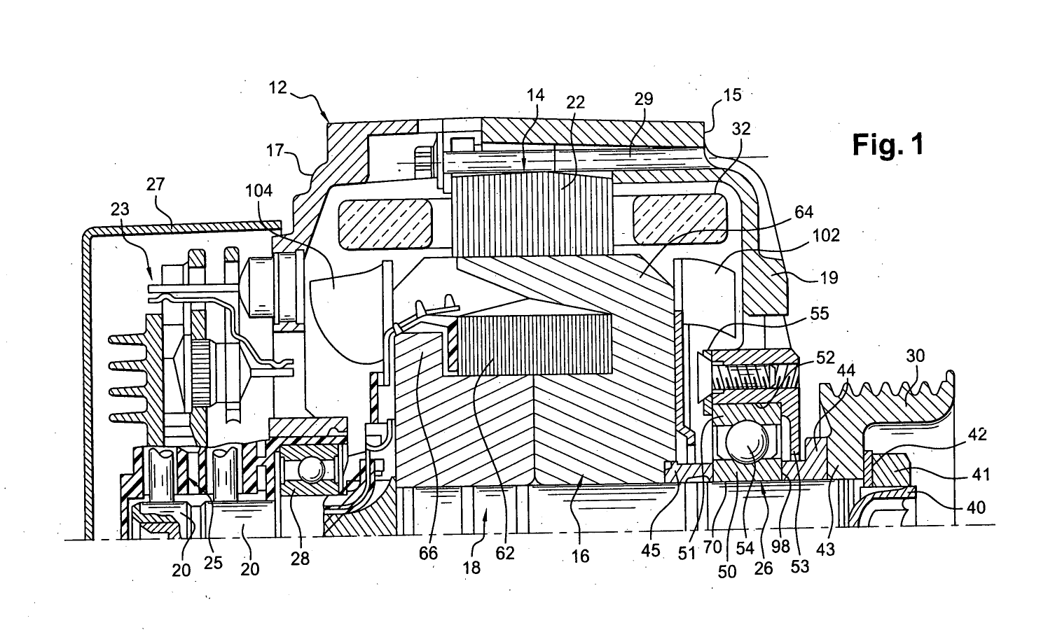

FIG. 1 shows a polyphase alternator, which in this example is three-phase, for a motor vehicle, consisting mainly of a casing 12, in two parts 15 and 17 which are connected to the earth of the motor vehicle and which carry two main internal components which are a stator 14 and a rotor 16, in the manner described for example in the document EP-B-0 515 259, to which reference should be made for more detail. The parts 15 and 17 accordingly include lugs for their fastening to a fixed part of the vehicle.

The stator 14 surrounds the rotor 16, which is fixed to a rotor shaft 18 on the rear end of which are fixed two slip rings 20, while a pulley 30 is fixed to the front end of the shaft 18. This pulley, which in this example is grooved, is arranged to receive a drive belt of complementary form which is part of a motion transmission device driven by the internal combustion engine of the motor vehicle.

The stator 14 comprises a body 22 which, in this example, consists mainly of an axial stack of transverse soft iron laminations.

The inner annular face of the body 22 has axial grooves, which extend radially outwards and which receive axial tails of electric windings 32. The grooves are open on the inside as can be seen for example in the document FR-A-2 603 429.

Each electrical winding 32 consists for example of a coil wound in turns of an electrical conductive element, in this example copper wire, which is coated with at least one layer of electrically insulating material, for example a polyester in two layers, one of which is of the polyimide type, the other being of the polyamide imide type.

The axial tails are extended by transverse junction tails which form chignons (not shown), which project on either side of the body 22 of the stator 14 in accordance with FIG. 1.

In another version, use is made of conductors in the form of bars, such as hairpins, of circular or rectangular cross section, which are mounted in the axial grooves of the stator 14 as described in the document WO-92/06527. In a further version, four electrically conductive elements are superimposed radially on each other in each groove, being mounted in the manner described in the Application document FR 01 04770 filed on Apr. 5, 2001.

In this example, the rotor 16 is a claw-type rotor which has a cylindrical electrical excitation winding 62, which is mounted between two metal plates 64 and 66, each of which has at its outer periphery claws which extend axially towards the other plate 66 or 64. The ends of the winding 62 are connected to the slip rings 20 in the known way through connecting wires. The plates 66 and 64 in this example are extended at their inner periphery by a cylindrical portion for carrying the winding 62. In another version, a cylindrical core is mounted on the shaft 18 and is interposed between the two plates in order to carry the winding 62.

Each assembly of the plates with the claws constitutes a pole wheel, which in the present case is of magnetic steel. Each pole wheel is fixed on the shaft by knurled portions of the shaft 18. The claws are offset circumferentially as between one pole wheel and the other, so that one claw of the plate 64 is interleaved between two adjacent claws of the plate 66, and vice versa. For more detail, reference should be made to the document EP-B-0 515 259, which also shows the other components of the alternator. The alternator is accordingly, here, internally ventilated, with each plate 64 and 66 carrying a respective fan 102, 104 adjacent to the corresponding part 15 or 17 of the casing.

Each part 15 or 17 of the casing 12 has openings for flow of air, and carries a central ball bearing 26, 28, for rotational support of the front and rear ends respectively of the shaft 18. Thus, one of these casing parts is called the front bearing 15, i.e. the one adjacent to the pulley 30, while the other is the rear bearing 17. The rear bearing 17 carries a rectifier device 23 for the alternating current produced by the stator, and a brush carrier 25, the brushes of which cooperate with the slip rings 20.

A protective cover 27 is also provided, which is fixed with respect to the rear bearing 17 and which covers firstly the brush carrier 25, which is connected in the usual way to a regulating device for the purpose of regulating the current and voltage in the winding 62, and secondly the rectifier device 23, which has diodes that, in this example, are mounted in head-to-toe relationship as can be seen in FIG. 1. The rectifier device 23 includes the rear bearing 17 carrying the so-called negative diodes, a positive metallic radiator carrying the so-called positive diodes, and a connector interposed between the rear bearing of the positive radiator, in particular for connecting the diodes as described in the document FR-A-2 734 425, to which reference should be made for more detail.

The front bearing 15 and rear bearing 17 are of metal, being based on aluminium in the present case, and are of hollow form delimited by a transverse plate element, carrying the corresponding ball bearing 26 or 28, and by an axially oriented peripheral flange, one of which is shouldered internally in this example, so as to carry the stack of laminations in the body of the stator, secured by means of screws 29 which are in engagement on a crown forming part of an annular spacer element (which is not given a reference numeral), which has a radial flange engaging on the bearing 15 in order to grip the body 22 between the crown and the above mentioned shoulder. In another version, the bearing 17 also has a shoulder, so that the body 22 is gripped between both shoulders of the bearings 15 and 17.

The radial plate elements and the flanges, in the known way, have apertures for flow of air. Thus the flanges have apertures facing axial ends of the windings 32, or so-called chignons, which project axially from the body 22 of the stator 14, while the radial plates have apertures facing the blades of the fans 102 and 104. These bearings are fastened by means of screws or tie-bars, as can be seen for example in FIG. 1 of the document EP-B-0 515 259 mentioned above. In a further version, a single fan is fitted on the outside in the region of the pulley. In yet another version, the bearings 15 and 17 are provided with internal channels for flow of a coolant liquid, such as the engine coolant of the motor vehicle.

The pulley 13 is hollow internally, for fitting of the threaded front end portion 40 of the shaft 18 within it, with a nut 41 and a thrust washer 42 interposed between the transverse base portion 43 of the pulley 18 and the nut 41, which is screwed on the threaded end portion 40. The base portion 43 has a central hole, together with a first annular spacer portion 44 and a second annular spacer portion 45, for passage of the shaft 18 through it. The inner race 50 of the ball bearing 26 is seamed on a smooth cylindrical surface 70 of the shaft 18; the spacer portions 44 and 45 are mounted on either side of this race 50. The outer race 51 of the bearing 26 is mounted in a housing formed in the inner periphery of the transverse plate portion 19 of the front bearing 15, that is to say centrally in the front bearing 15.

The housing is bounded by an axially oriented annular surface 52 which is extended radially inwards by a transverse wall 53 that surrounds, with a slight clearance, the first spacer portion 44. The front face of the ball race 51 is in engagement on the outer periphery of the portion 53, while the rear face of the race 51 is in contact with a ring 55, which is secured by screws on the plate portion 19 radially outside the surface 52, which is in contact with the outer periphery of the outer ball race 51. Accordingly, the race 51 is gripped between the ring 55 and the wall 53. The first annular spacer portion 44 is located axially between the base portion 43 of the pulley 30 and the inner ball race 50 of the ball bearing 26.

In the known way, the races 50 and 51 have tracks for the balls 54 which are interposed radially between the races 50 and 51. The bearing 26 is preferably lubricated conventionally with grease, and seals fixed with respect to the outer race 51 are arranged at each axial end of the ball bearing so as to prevent escape of grease, so that the bearing 26 is sealed. A cage is provided for retaining the balls 54. The seals (not given reference numerals) of the ball bearing 26 are shown by broken lines. These seals are behind the axial ends of the ball bearing 26. The seals are fixed with respect to the outer race 51 of the bearing, and are in contact with the outer periphery of the inner race 50.

The first spacer portion 54 is tubular in form and has at its front end a transversely oriented annular flange for contact with the base portion 43. In another version, the first spacer portion is integral with the base portion 43 which is accordingly made thicker. The second spacer portion 45 is tubular, and is located axially between the inner race 50 of the ball bearing 26 and the plate portion 64 of the adjacent pole wheel. The shaft 18 is shouldered in line with the rear face of the plate 66 of the other pole wheel.

Thus, the pulley 43, the inner ball race 50 and the plates 64 and 66 are immobilised axially through the spacer portions 44 and 45, by the tightening of the nut 41 which bears on the washer 42, the plates 64 and 66 being secured against rotation because the knurling on the shaft 18, which is harder than the plates 64 and 66, scores the central bores of the plates 66 and 64 to form small grooves while the shaft 18 is being force-fitted in those central bores.

The pulley 30 is thus secured to the shaft 18 against rotation, due to the gripping effect thus produced. The ball race 50 is also fixed against rotation with respect to the shaft 18 because it is force-fitted on the latter. This force-fitting is tighter than the fitting of the outer race 51 within the surface 52.

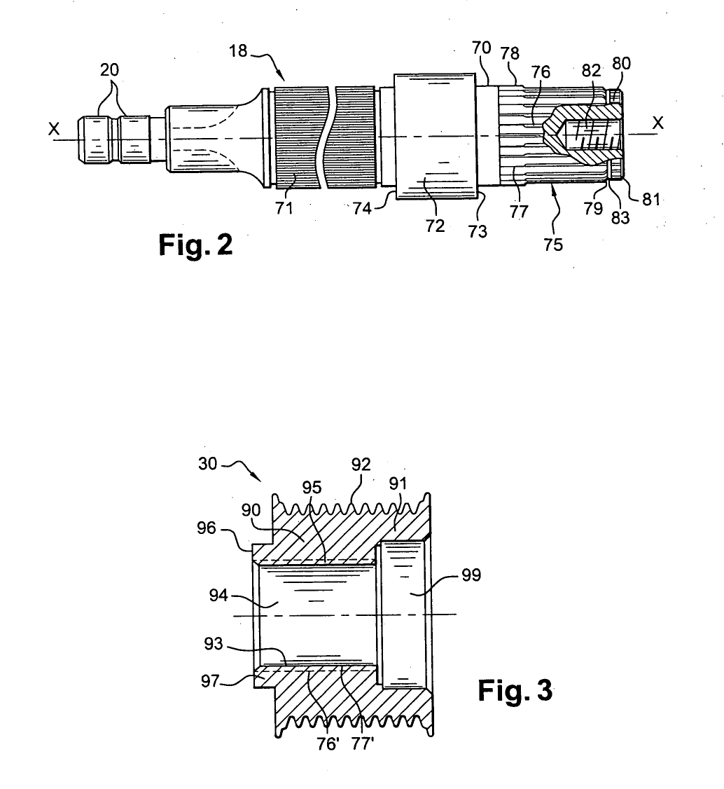

FIG. 2 shows a rotor shaft 18 in accordance with the invention. The shaft 18 is the rotor shaft of a rotary electrical machine which is for example an alternator or an alternator starter for a motor vehicle.

The shaft 18 includes a cylindrical body which comprises a convex knurled portion 71 adapted to receive the pole wheels. More precisely, the pole wheels are force-fitted on the portion 71, which scores grooves in the latter. The shaft 18 has an axial axis of symmetry X-X which constitutes the axis of rotation of the rotary electrical machine.

The knurled portion 71 is extended forward by an intermediate cylindrical portion 72, having an outer diameter which is greater than the outer diameter of the body 71 of the shaft 18. This intermediate portion is preferably formed integrally with the shaft. In a modified version, the intermediate portion may be a ring which is welded on the shaft 18. The intermediate portion 72 is delimited axially by a front transverse terminal shoulder 73 which engages against the ball bearing 26, and a rear transverse terminal shoulder 74 which abuts against the front pole wheel 64. The intermediate portion thus forms a spacing element which is delimited by two radially oriented shoulders 73 and 74.

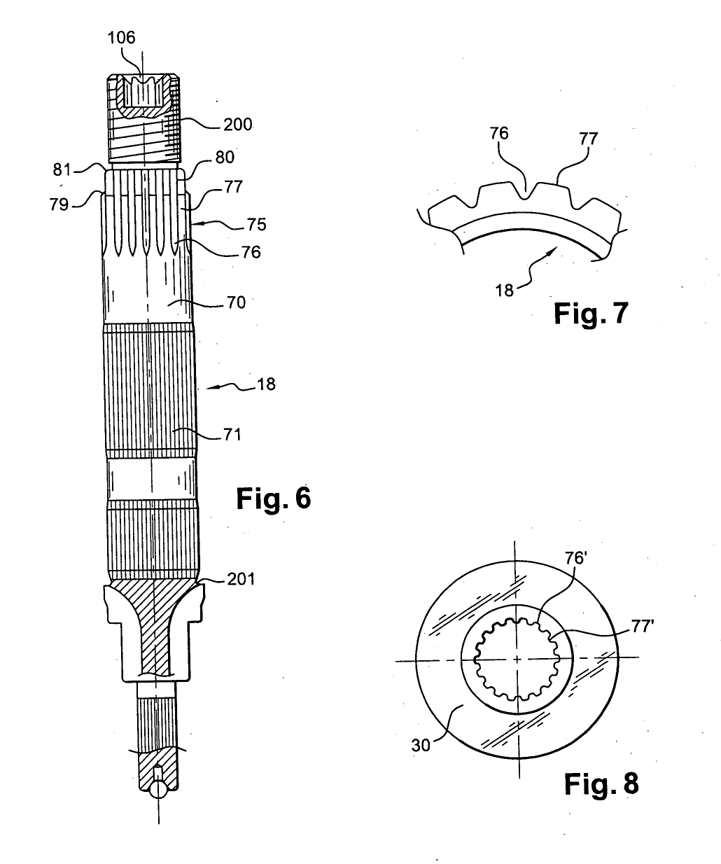

In a modified version, and as can be seen in FIG. 6, the shaft 18 does not have an intermediate portion 72. The shaft is therefore a so-called “smooth” shaft. This shaft has the advantage that it is inexpensive to manufacture because of the omission of the machining operation on either side of the intermediate portion. This smooth shaft includes a groove 201 for attachment of the rear pole wheel by seaming, thereby locating the pole wheels against axial movement.

The front shoulder 73 is extended by a smooth cylindrical surface 70 which is arranged to receive the ball bearing 26. The smooth cylindrical surface 70 is extended forward by an externally splined portion 75 at the free front end, including on its outer periphery axial splines 76 and axial teeth 77 arranged alternately.

The splined outer portion 75 is stepped in diameter externally, the base circle of the bases of the splines 76 being identical. More precisely, the splined outer portion 75 includes at the rear end a short portion 78 which includes teeth 77 having an outer diameter which is equal to the outer diameter of the cylindrical surface 70. At the front end, the teeth 77 of the splined outer portion 75 are arranged to cooperate lightly with splines of the pulley 30.

Preferably, the ball bearing is fitted with its tightness being adjusted simultaneously on the cylindrical smooth surface 70 and on the short splined portion 78.

In a modified version, and as can be seen in FIG. 6, the ball bearing is essentially fitted on the smooth cylindrical portion 70.

The free front end of the teeth 77 includes a chamfer 79, the purpose of which is to make it easier to fit the pulley.

Preferably, the free front end of the shaft 18 has a pilot end configuration 80 which is also intended to facilitate fitting of the pulley. This pilot end also has a chamfer 81 to make fitting of the pulley even easier. The outer diameter of the pilot end is substantially equal to the inner diameter of the teeth 77′ of the pulley.

The free front end portion of the shaft preferably includes an internal, threaded socket 82, which is coaxial with the axis X-X for the purpose of fitting the pulley on the shaft.

Preferably, the form adopted for the set of teeth in the splines is the known, so-called “developed circle” form defined by the involute function currently employed for meshing profiles. This form of tooth is preferably formed by milling or rolling.

In a further version, and as can be seen in FIG. 6, the free front end portion of the shaft 18 includes a threaded front end portion 200 which is arranged to receive a nut for fitting of the splined pulley on the splined shaft 18.

As is shown in FIG. 3, the pulley 30 includes a solid body portion 90 made in the form of a thick disc, which is extended forward at its radial outer periphery by a cylindrical annular skirt portion 91, oriented axially and having the axis X-X. The solid body portion 90 and the annular cylindrical skirt portion 91 have a profiled radially outer surface 92 which defines a peripheral working zone adapted to cooperate with a drive belt, not shown, in accordance with a known design.

In the example shown in FIG. 3, but without limitation, the working zone of the pulley 30, constituted by the profiled outer radial surface 92 and adapted to cooperate with the belt, is grooved in this example so as to cooperate with a grooved belt. In a modified version, the radial surface 92 could be toothed in order to cooperate with a belt formed with recesses. It all depends on the application.

The pulley 30 is for example moulded in one piece, and its body 90 is extended at its outer radial periphery by an annular pulley hub 93 which is in the form of an axially oriented thick sleeve that extends generally axially forward with respect to the transverse body 90.

The annular pulley core 93, in the form of a sleeve, thus generally delimits an open axial hole 94 which extends through it and which includes, in accordance with the features of the invention, a splined internal portion 95 which consists of an alternate arrangement of axial splines 76′ and axial teeth 77′, which are adapted to cooperate with the splined outer portion 75 of the shaft 18 of the rotor, so as to permit the pulley 30 to be assembled by force-fitting of its hub 93 on the shaft 18.

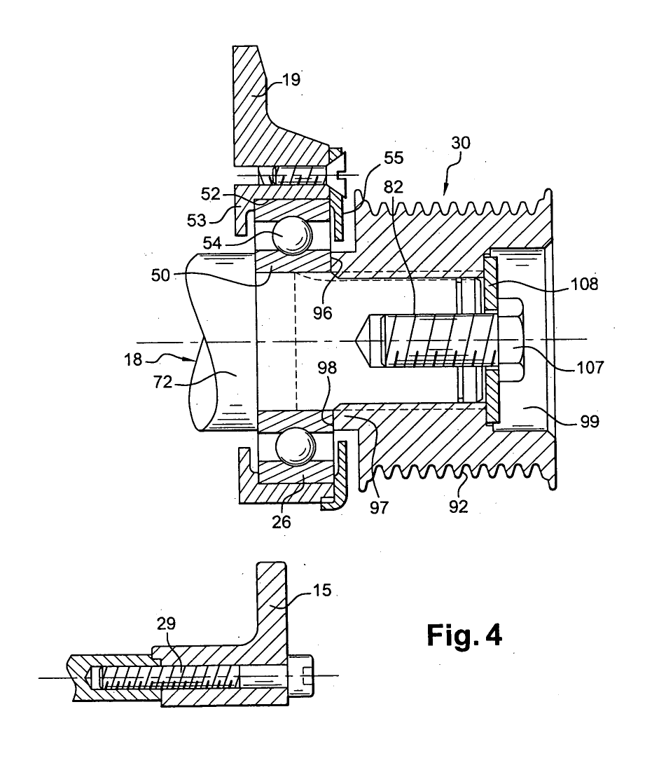

The annular hub 93 of the pulley is delimited axially at the rear end by a transverse shoulder 96 formed at the free rear end of a tubular axial extension portion 97, the diameter of which is smaller than that of the hub 93. As can be seen in FIG. 4, this shoulder 96 comes into axial abutment against a transverse face 98 of the axial end of the inner race 50 of a front ball bearing 26 for guiding the rotor shaft 18 in rotation.

By contrast with FIG. 1, and as can be seen in FIG. 4, the front face of the outer race 51 of the ball bearing 26 is in contact with the ring 55, which is secured by screws on the plate portion 19 radially outside the surface 52, which is in contact with the outer periphery of the outer race 51. This structure can of course be reversed.

Without departing from the scope of the invention, the shoulder 96 of the pulley 30 could also come into engagement against a corresponding shoulder formed directly on the rotor shaft 18.

The front end of the pulley defines, at the level of the cylindrical skirt portion 91, a front opening 99 which is stepped in diameter and which is adapted to receive, for example, a wide thrust ring 108 for axial retention of the force-fitted pulley. The front opening 99 is preferably chamfered at its front end.

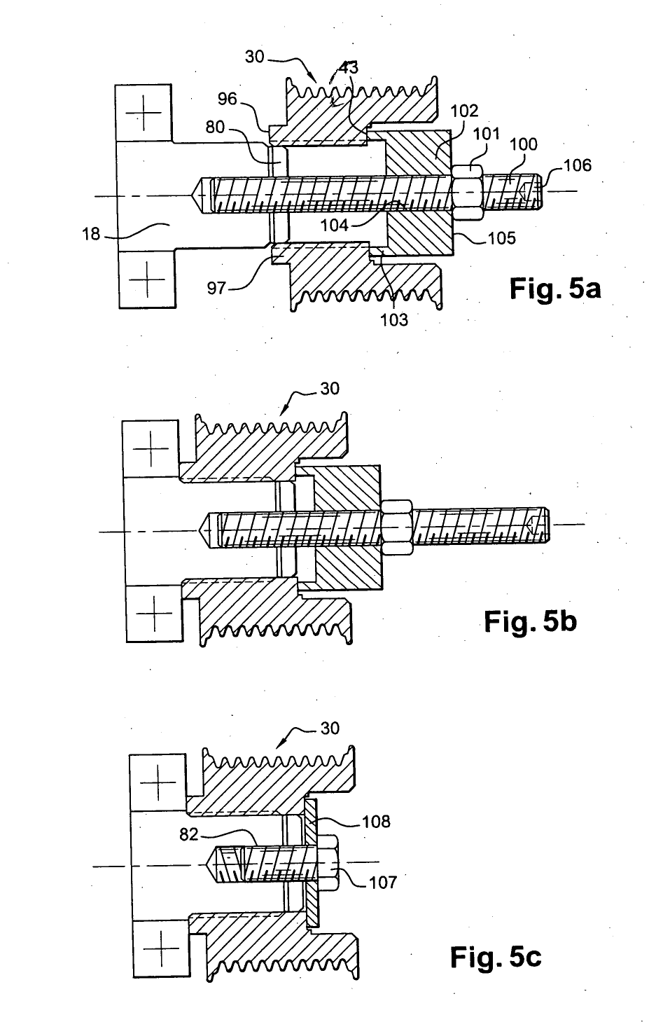

FIGS. 5a, 5b and 5c show, by way of example, a method of fitting the pulley 30 on the shaft 18 according to the invention.

By way of example, fitting of the pulley 30 on the shaft 18 is carried out in the following way:
a threaded rod 100 is screwed into the threaded hole 82 in the shaft.
the axially oriented annular extension portion 97 of the pulley 30 is offered up to the pilot end 80.
the pulley is indexed by placing its splines 76′ in facing relationship with the teeth 77 of the shaft.
at this stage of the process, in a modified version, the pulley could be heated to facilitate its fitting, to a temperature of 170 degrees for example.
a spacing piece 102 is fitted in the central front opening 99 of the pulley, with the rear face of the rear tubular end portion 103 of the spacing piece 102 coming into abutment against the transverse front base portion 43 of the pulley, while the threaded rod passes freely into the interior of a bore 104 of the spacing piece 102, coaxial with the axis X-X.
a nut 101 is screwed on the threaded rod 100 in contact with the front face 105 of the spacing piece 102, so as to attach and securely hold the pulley on the pilot end 80 at the free front end of the shaft 18.
the threaded rod 100 is tightened.
the nut 101 continues to be screwed up towards the rear along the threaded rod 100, so as to fit the pulley on the front splined portion 75 of the shaft 18. The shaft is thereby “drawn” until the other face of the pulley is in abutment on the ball bearing.
the screwing-up operation is stopped when the transverse shoulder 96 of the pulley 30 comes into abutment against the front axial end 98 of the inner race 50 of the front ball bearing of the electrical machine. FIG. 5b shows an assembly of a pulley on a shaft according to the invention at the end of the screwing-up operation.
the threaded rod 100, carrying the spacing piece 102 and nut 101, is then withdrawn.

Tightening of the threaded rod 100 is of course carried out with the aid of a complementary tool. The threaded rod 100 has at its free front end a central socket 106 which is for example serrated internally. Thus, the threaded rod 100 is prevented from rotating by a complementary tool (not shown), serrated on the outside, which is introduced into the serrated socket 106 in the threaded rod to prevent it from rotating. For example, a tool and “Torsc” socket, or a hexagonal tool and socket, may be used.

While being screwed up, the nut 101 transmits an axial rearward force on the front face 105 of the spacing piece, this axial force being then transmitted to the transverse base portion 43 of the pulley through the cylindrical surface 103 of the spacing piece.

In a modified version shown in FIG. 5c, a stud 107 is screwed into the threaded hole 82 in the front end of the shaft 18, after a wide thrust ring 108 has been placed against the transverse base portion 43 of the pulley. Thus, any risk of disengagement of the pulley on the shaft is avoided.

In a further modified version and as shown in FIG. 6, fitting of the splined pulley on the shaft 18 is performed along the same lines as the fitting of a splined pulley on the shaft corresponding to FIG. 2 described above. Thus, the fitting procedure may be broken down as follows:
the axially oriented annular extension portion 97 of the pulley 30 is offered up to the pilot end 80.
the pulley is indexed by placing its splines 76′ in facing relationship with the teeth 77 of the shaft.
at this stage of the process, in a modified version, the pulley may be heated to facilitate its fitting, to a temperature of 170 degrees for example.
the shaft 18 is held against movement with the aid of a tool co-operating in mating relationship with the socket 106 at the front end of the shaft 18.
the nut is screwed up towards the rear on the thread 200 until the pulley comes into abutment against the ball bearing.
the screwing-up operation is stopped when the transverse shoulder 96 of the pulley 30 comes into abutment against the front axial end 98 of the inner race 50 of the front ball bearing of the electrical machine.

In a modification, a washer may be inserted between the nut and the front face of the pulley.

Once the pulley has been fitted, the nut is withdrawn from the thread 200, and the latter can be used for another fitting operation. It is clearly possible to leave the nut on the thread for safety reasons, even though it contributes nothing to transmission of the torque.

As in the two fitting operations described above, it is, in a further modified embodiment, possible to carry out heating of the splined pulley 30 to facilitate its force-fitting on the shaft 18. This heating action enables a perfect fit of the pulley on the shaft 18 to be guaranteed. In addition, once it is mounted on the shaft, it is possible easily to remove the splined pulley with heating action. It should be clearly noted that the latter is not possible with a pulley which is fitted in accordance with a method involving knurling on the shaft.

Other methods for fitting the pulley may of course be envisaged, such as for example a pusher device which enables the splined pulley to be pushed on the splined shaft 18 until the latter comes into abutment against the ball bearing.

In yet another version, it can be envisaged that the teeth are “conical”, in other words that the thickness of the tooth varies linearly over all or part of its useful length. Fitting is initially easy, since the adjustment between the shaft and pulley is by sliding action, and tightening increases as engagement increases.

In the case of fitting of a pulley on a shaft by means of force-fitting on splines, only the flanks of the teeth of the pulley and shaft are in contact, which thereby gives centring of the pulley on the shaft, on the one hand, and transmission of the torque employed in the particular application on the other hand, and this is true in either direction, depending on whether the machine is working as a motor or as a generator.

Due to the belt and pulley transmission, the shaft works in rotary bending mode. It is therefore convenient to optimise the geometry and the process of obtaining the splines, to give maximum fatigue strength. The splines on the shaft are preferably cold-rolled.

The splines are made tight, such that no clearance is possible between the shaft 18 and pulley 30. Without this, acyclic effects, sudden variations in engine speed, and reversals of the direction of the torque, passing into the transmission, could give rise to work hardening or even fracture of the splines and fracture of the shaft. The fit is preferably between 50 and 200 microns.

The quality of the assembly and the value of the maximum torque which can be transmitted no longer depend on the surface conditions of the various components in contact with the pulley. Thus, in accordance with the invention, transmission of the torque is achieved by means of positive coupling through the splines on the shaft and pulley.

Due to the pulley-and-belt transmission, there is a slight deflection of the shaft under the tangential force set up by the torque which is transmitted by the pulley 30. There may therefore be a “nodding” effect, giving an axial sliding effect of the pulley 30 on the shaft 18, even though they have been tightened up. It is this sliding movement which it is desirable to control by adopting for example an axial locating means, such as the following:
a screw (with or without a braking device),
a nut (with or without a braking device),
seaming (with local deformation) of the unsplined shaft end,
a washer, a circlip, or an elastic cotter,
deformation (expansion) of the shaft after fitting of the pulley, such as for example axial compression of the shaft in order to expand the splines after fitting of the pulley, or again, by the use of a hollow shaft with a conical thread which enables expansion to be carried out with the aid of a conical tool.

In a modified version of the process, it is possible to consider that the axial location of the pulley on the shaft is a direct consequence of the tightening of the pulley/shaft adjustment. It is thus unnecessary to add an axial retaining device of the screw, nut, or circlip, or other type of locating means, as the displacement caused by the above mentioned nodding effect is very limited.

Another alternative version consists in making the shaft so that its end has a cutting edge over the whole of the perimeter of the set of teeth, and the pulley has a smooth bore. The spline of the pulley will be made by removal of material during force-fitting of the shaft. In this case it is necessary to carry out surface hardening of the teeth on the shaft. In addition it should be noted that, in the event of dismantling, the components cannot be re-used.

Due to the large variations in temperature which may occur, it is necessary—in order to guarantee tightness of the coupling in operation—to choose preferentially for the shaft and pulley materials having coefficients of expansion which are close to each other, or even identical.

By virtue of the arrangement according to the invention, the maximum torque which can be transmitted by the assembly is no longer dependent on the axial gripping of the pulley, that is to say on the gripping torque of the nut as in the state of the art up to now.

1. The combination of a drive pulley (30) with the rotor of a rotary electrical machine for a motor vehicle, especially an alternator or an alternator starter, comprising, firstly, a shaft (18) carrying a rotor and a front ball bearing (26), and secondly, a pulley (30) having a peripheral working zone (92) adapted to cooperate with a drive belt, together with a central hub (93) having an axial hole (94) for passage of the shaft (18) of the rotor through it, characterised in that the pulley (30) includes a splined inner portion (95) for its attachment, by force-fitting, on a complementary splined outer portion of the shaft (18) of the rotor, the latter having on its outer periphery an alternate arrangement of axial splines (76) and axial teeth (77).

2. The combination according to claim 1, characterised in that the central hub (93) includes a transverse shoulder (96) adapted to come into abutment against a transverse face (98) of an inner race (50) of the ball bearing (26) that guides the shaft of the rotor (18) in rotation.

3. The combination according to claim 1, characterised in that the shaft (18) includes an intermediate portion (72) which is extended in length by a smooth cylindrical surface (70) adapted to receive the ball bearing (26).

4. The combination according to claim 3, characterised in that the smooth cylindrical surface (70) is extended in length by a splined external free end portion (75) which includes on its outer periphery an alternate arrangement of axial splines (76) and axial teeth (77).

5. The combination according to claim 4, characterised in that the splined external free end portion (75) is stepped in diameter on the outside.

6. The combination according to claim 5, characterised in that the splined external free end portion (75) includes a short portion (78) which includes teeth (77), the outer diameter of which is equal to the outer diameter of the cylindrical surface (70).

7. The combination according to claim 6, characterised in that the ball bearing (26) is mounted both on the smooth cylindrical surface (70) and on the short splined portion (78).

8. The combination according to claim 1, characterised in that the free front end of the teeth (77) has a chamfer (79) for facilitating fitting of the pulley.

9. The combination according to claim 1, characterised in that the free end of the shaft (18) includes a pilot end configuration (80) adapted to facilitate fitting of the pulley (30).

10. The combination according to claim 9, characterised in that the pilot end configuration (80) comprises a chamfer (81) to facilitate fitting of the pulley (30).

11. The combination according to claim 10, characterised in that the outer diameter of the pilot end configuration (80) is substantially equal to the inner diameter of a set of teeth (77′) on the pulley (30).

12. The combination according to claim 1, characterised in that the free end of the shaft (18) includes a threaded socket (82) coaxial with the axis (X-X) of the shaft (18), for the purpose of fitting the pulley.

13. The combination according to claim 1, characterised in that the splined internal portion (95) of the pulley (30) consists of an alternate arrangement of axial splines (76′) and axial teeth (77′).

14. The combination according to claim 1, characterised in that the set of teeth is conical, whereby the tooth thickness varies linearly over all or part of the length used in the force-fitting assembly operation.

15. The combination according to claim 1, characterised in that, for force-fitting the pulley (30) on the shaft (18), it is only the flanks of the teeth (77, 77′) of the pulley (30) and shaft (18) that are in contact.

16. The combination according to claim 15, characterised in that, for the force-fitting of the pulley (30) on the shaft (18), the interference is in the range between 50 and 200 microns.

17. The combination according to claim 1, characterised in that the pulley (30) is located by an axial locating device.

18. The combination according to claim 1, characterised in that the free end of the shaft (18) has a cutting edge over the whole perimeter of the set of teeth, while the pulley (30) has a smooth annular hub (93) for the formation of the splines of the pulley (30) by scoring during the force-fitting operation.

19. The combination according to claim 1, characterised in that the shaft (18) and pulley (30) are formed from materials having coefficients of expansion which are close or identical to each other, whereby to guarantee the tight fit of the pulley on the shaft.

20. A method for assembly of the combination according to claim 1, characterised in that, starting with a pulley (30) having a transverse front base portion (43), an axially oriented annular extension portion (97) with a transverse shoulder (96), and a central front aperture (99),
a threaded rod (100) is fitted by screw fastening in a threaded hole (82) in the shaft (18) of the rotor;
an axially oriented annular extension portion (97) of the pulley (30) is offered up to a pilot end configuration (80) of the shaft (18);
the pulley (30) is indexed by placing its splines (76′) in facing relationship with the teeth (77) of the shaft;
a spacing piece (102), having an internal bore (104) and a tubular rear end portion (103), is mounted within a central front aperture (99) of the pulley, a rear face of the tubular rear end portion (103) of the spacing piece (102) coming into abutment against the transverse front base portion (43) of the pulley, while the threaded rod passes freely into the interior of the bore (104) of the spacing piece (102);
a nut (101) is screwed on the threaded rod (100) in contact with the front face (105) of the spacing piece (102), whereby to offer up, and firmly hold, the pulley on the pilot end configuration (80) of the free front end portion of the shaft (18);
the threaded rod (100) is held against movement;
the nut (101) continues to be screwed up towards the rear along the threaded rod (100), whereby to fit the pulley over the splined external portion (75) of the shaft (18), so as to exert a pulling force on the shaft;
the screwing-up operation is stopped when the transverse shoulder (96) on the pulley (30) comes into abutment against the axial front end (98) of the inner ball race (50) of the front ball bearing of the electrical machine; and
the threaded rod (100), carrying the spacing piece (102) and the nut (101), is withdrawn.
